(19) United States
(12) Patent Application Publication
(10) Pub. No.: US 2001/0051327 A1
(43) Pub. Date: Dec. 13, 2001

(54) Device for supporting training for prevention against incontinence of urine

(75) Inventors: Tadashi Hatano, Naha-Shi (JP); Kimio Sugaya, Naha-Shi (JP); Yusuke Ito, Tokyo (JP); Yoshinori Haraguchi, Tokyo (JP)

Correspondence Address: McDERMOTT, WILL & EMERY, 600 13th Street, N.W., Washington, DC, 20005-3096, US

(73) Assignee: TANITA CORPORATION

(21) Appl. No.: 09/852,083

(22) Filed: May 10, 2001

(30) Foreign Application Priority Data
May 30, 2000 (JP) 2000-159433

(51) Int. Cl. G09B 23/28

(52) U.S. Cl. 434/262

(57) ABSTRACT

Disclosed is a device for supporting a training for prevention against incontinence of urine, comprising: an input unit; an indicator unit; a decision unit; and a display unit. The input unit enters the fact that a user is performing the training for prevention against incontinence of urine, and the indicator unit produces a timing indication for the training for prevention against incontinence of urine. Furthermore, the decision unit determines that the training for prevention against incontinence of urine is correctly performed on the basis of the input signal sent from the input unit, and the display unit performs displaying according to the result of decision made by the decision unit.

### BACKGROUND OF THE INVENTION

1. Field of the Invention

The present invention relates to a device for supporting a training for prevention against incontinence of urine that can effectively support and prompt a user to perform the training for prevention against incontinence of urine by exercising pelvic floor muscles.

2. Description of the Prior Art

Incontinence of urine, a kind of disease with which great many women are affected, is well known. The number of such women is said to reach over 25% of whole women population in the world. The disease is so serious that WHO (World Health Organization) designates it as one of the three most critical diseases in the world. In general it has been known that training or exercising the pelvic floor muscles is effective to prevent or remedy such incontinence of urine (in particular those induced due to abdominal pressure). Also known in the art is a device for exercising vaginal muscles by directly inserting it into the vagina, as disclosed in the applicant's Japanese Patent Application Laid-Open No. 63-294850.

However, the device for exercising vaginal muscles by directly inserting it into the vagina is defective in that it is not easy to insert the device into the vagina and a user may feel pain upon insertion or in use of the device. In addition, due to the configuration of the device, it is not possible to use it everywhere, and therefore, the exercise of vaginal muscles is difficult to perform in view of one's sense of shame.

The training for prevention against incontinence of urine is a spontaneous remedy process mainly based upon one's own will. Therefore, the strong will and patience is necessary to continuously perform the training every day. In the actual circumstances, however, such training does not tend to be performed continuously.

Furthermore, such training for prevention against incontinence of urine is not sure to provide the effectiveness for the user, because there is always any possibility that the training is not periodically and regularly performed, and it is not correctly performed.

On the other hand, it has been said that corpulent persons are likely to be suffered from the incontinence of urine. Unfortunately, in the past, attention has been paid only to an exercise of pelvic floor muscles to treat the incontinence of urine. Accordingly, up to now, there has been no useful remedy process available for treating the incontinence of urine, while improving the body feature of the persons.

### SUMMARY OF THE INVENTION

In view of the above, an object of the present invention is to provide a device for supporting a training for prevention against incontinence of urine that can solve the problems in the prior art.

According to one aspect of the present invention, there is provided a device for supporting a training for prevention against incontinence of urine, comprising: an input unit; an indicator unit; a decision unit; and a display unit, whereby

said input unit enters the fact that a user is performing the training for prevention against incontinence of urine;

said indicator unit produces a timing indication for the training for prevention against incontinence of urine;

said decision unit determines that the training for prevention against incontinence of urine is correctly performed on the basis of the input signal sent from the input unit; and

said display unit performs displaying according to the result of decision made by the decision unit.

According to another aspect of the present invention, there is provided a device for supporting a training for prevention against incontinence of urine, comprising: an input unit; an indicator unit; a step counter unit; a decision unit; and a display unit, whereby

said input unit enters the fact that a user is performing the training for prevention against incontinence of urine;

said indicator unit produces a timing indication for the training for prevention against incontinence of urine;

said step counter unit counts the number of steps based on a walking exercise of the user;

said decision unit determines that the training for prevention against incontinence of urine is correctly performed on the basis of the input signal sent from the input means; and

said display unit performs displaying according to the result of decision made by the decision unit and the number of steps counted by the step counter unit.

According to further aspect of the present invention, there is provided a device for supporting a training for prevention against incontinence of urine, incorporating a step counting function, comprising: an input unit; an indicator unit; a step counter unit; a decision unit; a timer unit; a training effort determination unit; a display unit; a scenario unit; and a controller unit, whereby

said input unit enters the fact that a user is performing the training for prevention against incontinence of urine;

said indicator unit produces a timing indication for the training for prevention against incontinence of urine;

said step counter unit counts the number of steps based on a walking exercise of the user;

said decision unit determines that the training for prevention against incontinence of urine is correctly performed on the basis of the input signal sent from the input means;

said timer unit controls the time;

said training effort determination unit determines a degree of the training effort on the basis of the result of decision made by the decision unit and/or the number of steps counted by the step counter unit within the predetermined time period controlled by the timer unit;

said display unit displays the degree of the training effort determined by the training effort determination unit;

said scenario unit changes the display of the degree of the training effort according to the predetermined scenario including a plurality of stages; and

said controller unit controls the transition of the stages of said predetermined scenario by the scenario unit, based on the degree of the training effort determined by the training effort determination means.

According to one embodiment of the present invention said training for prevention against incontinence of urine is a pelvic floor muscle training including fast fiber muscle and slow fiber muscle trainings.

According to another embodiment of the present invention said indicator unit produces the different timing indications for the fast fiber muscle and the slow fiber muscle trainings.

According to further embodiment of the present invention the timing indication for the fast fiber muscle training is such that relatively short exercise interval and rest interval are repeated with the same time period, and the timing indication for the slow fiber muscle training is such that relatively long exercise interval and rest interval are repeated alternately.

According to yet further embodiment of the present invention said relatively short exercise interval and rest interval for the fast fiber muscle training are repeated with the same time period of around 1 sec, and said relatively long exercise interval and rest interval for the slow fiber muscle training are repeated alternately with the time period of around 10 sec.

According to yet further embodiment of the present invention the device further comprises: an exercise start time setting unit; and an announcement unit, whereby

said exercise start time setting unit enters an exercise start time at which the user starts the training for prevention against incontinence of urine; and

said announcement unit announces when the timer unit indicates the exercise start time.

According to yet further embodiment of the present invention the timing indication for the training produced by said indicator unit is a visible indication.

### BRIEF DESCRIPTION OF THE DRAWINGS

Now the present invention will be described in detail with reference to the accompanying drawings, in which:

FIG. 1 is an external schematic view illustrating a device for supporting a training for prevention against incontinence of urine, including a step counting function, according to one embodiment of the present invention;

FIG. 2 is a block diagram illustrating electrical connections among the units and sections of the device for supporting the training for prevention against incontinence of urine, as shown in FIG. 1;

FIG. 3 is a flow chart illustrating a main routine executed by the device for supporting the training for prevention against incontinence of urine, as shown in FIG. 1;

FIG. 4 is a flow chart illustrating a basic process routine executed by the device for supporting the training for prevention against incontinence of urine, as shown in FIG. 1;

FIG. 5 is a flow chart illustrating a pelvic floor muscle training routine executed by the device for supporting the training for prevention against incontinence of urine, as shown in FIG. 1; and

FIG. 6 is a view illustrating one example of a display produced by the device for supporting the training for prevention against incontinence of urine, as shown in FIG. 1.

### PREFERRED EMBODIMENTS OF THE INVENTION

First, the fundamental concept of the present invention is described before the detailed description of a preferred embodiment of a device for supporting a training for prevention against incontinence of urine. The present invention supports a user to perform more effective training for prevention against incontinence of urine, especially by indicating to the user how to perform the training. In addition, the present invention prompts the user to perform the training for prevention against incontinence of urine, because as the user continues the training she can see some unique and interested pictures sequentially appeared on the display. Furthermore, the present invention improves the body feature such as corpulence of the user due to an incorporation of a walking step counting function, and therefore, provides more effective remedy for, and prevention against, incontinence of urine.

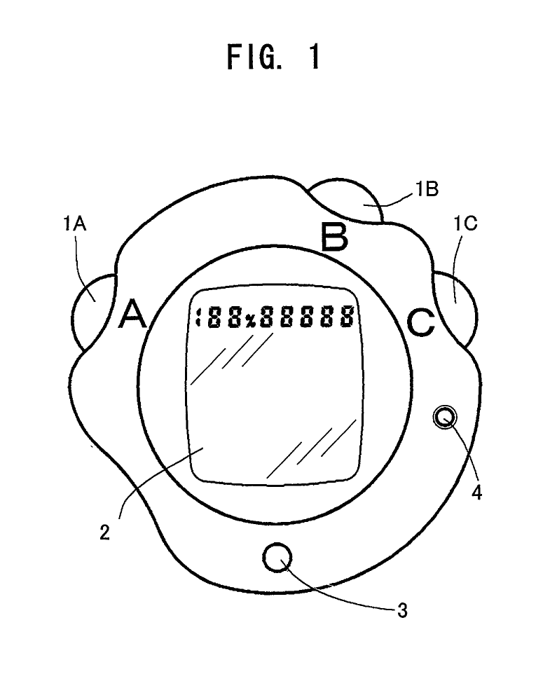

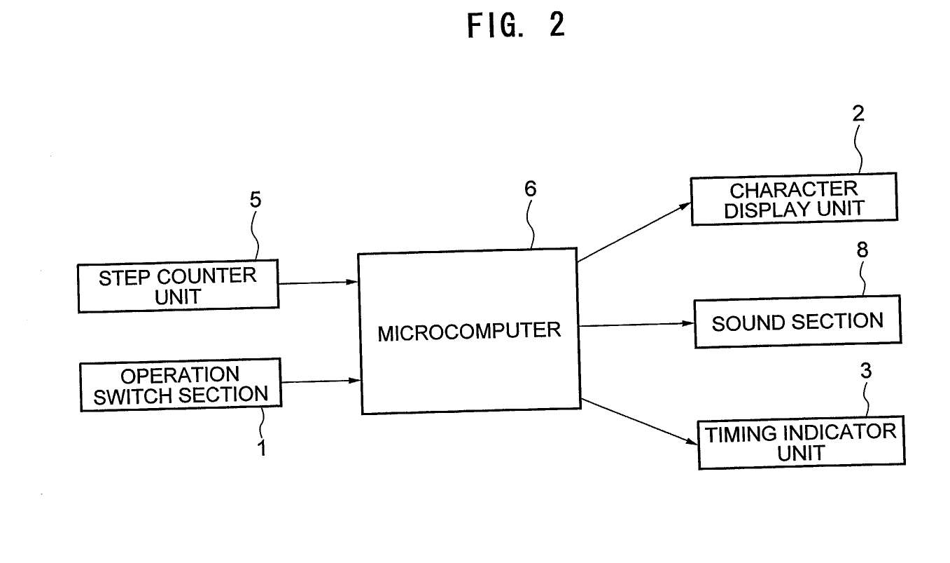

FIG. 1 is an external schematic view illustrating a device for supporting a training for prevention against incontinence of urine, incorporating a step counting function, according to one embodiment of the present invention. The device for supporting the training for prevention against incontinence of urine is of a portable type having such size that is entirely held in one hand of a user. As shown in FIG. 1, the device includes an operation switch section 1 (see FIG. 2) having three operation switches 1A, 1B and 1C, and a character display unit 2 consisting of a dot-matrix liquid crystal display element. The device further includes a timing indicator unit 3 formed from an LED element, and a reset switch 4 for initializing the data. Although not shown in FIG. 1, the device additionally includes, at the rear side thereof, a hole for transmitting a sound from a speaker in a sound section 8 (see FIG. 2), and a cover for accessing a battery. Furthermore, a step counter unit 5 (see FIG. 2) for counting the number of steps while the user walks is included within the device.

FIG. 2 is a block diagram illustrating electrical connections among the units and sections of the device for supporting the training for prevention against incontinence of urine, as shown in FIG. 1. As illustrated in FIG. 2, a microcomputer 6 is associated with the operation switch section 1, the character display unit 2, the timing indicator unit 3, the step counter unit 5 and the sound section 8. As described above, the operation switch section 1 includes three operation switches 1A, 1B and 1C. In particular, the operation switch 1A is used for an input switch upon performing the training, and the operation switches 1B and 1C are used for entering the personal data of the user and the like, as described hereafter. The step counter unit 5 acts substantially in the same manner as a common step counter or a pedometer to detect a walking exercise of the user, to produce a signal every time when the user steps, and to count the number of steps.

The microcomputer 6 receives the signals sent from the operation switch section 1 and the step counter unit 5, and makes decision whether the training is correctly performed on the basis of those signals. In addition the microcomputer 6 performs various arithmetic and control operations according to the programs already stored. The character display unit 2 gives various kinds of displays under the control of the microcomputer 6, as described hereafter. The timing indicator unit 3 gives to the user timing indications useful for performing the training for prevention against incontinence of urine under the control of the microcomputer 6, as described hereafter. The sound section 8 produces a buzzer sound under the control of the microcomputer 6, for the purpose as described hereafter.

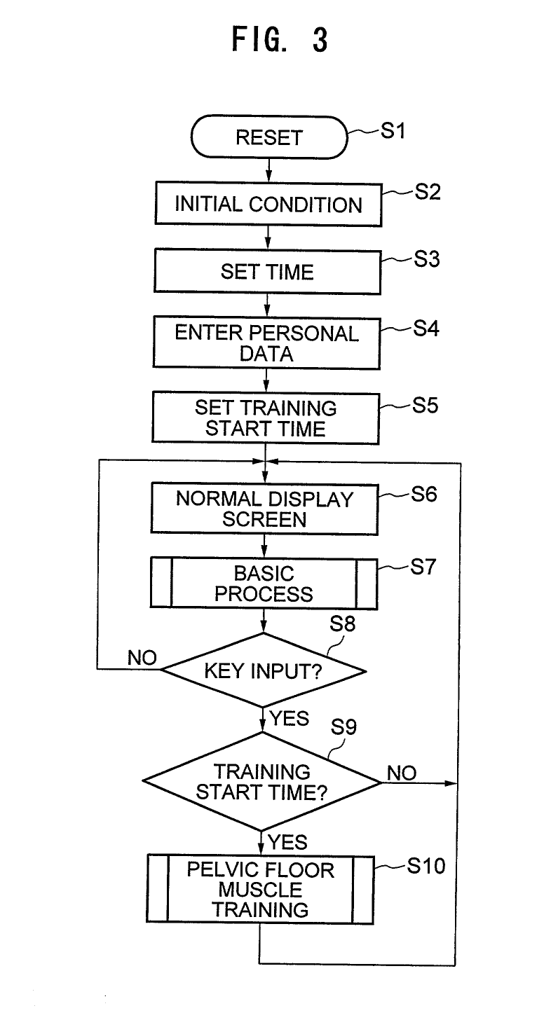

Referring now to flow charts of FIGS. 3 to 5, an operation and use of the device for supporting the training for prevention against incontinence of urine, as shown in FIG. 1, will be described in more detail.

FIG. 3 is a flow chart illustrating a main routine executed by the device for supporting the training for prevention against incontinence of urine. In the operation of the device, the user depresses the reset switch 4 for resetting the device (step S1). Then the device is in initial condition (step S2). Next the current time and the personal data is entered (steps S3 and S4). At this point the user operates the switches 1B and 1C to enter the personal data. The personal data includes height, body weight, sex, age, step width, etc., of the user, for example. The construction and operation of these data input switches are well known in the art, and therefore, no further description will be made here.

Then the training start time for pelvic floor muscle training is set (step S5). That is to say, the time at which the pelvic floor muscle training is to be started in a day is set. In general the training start time is set so that the training is started three times a day, for example, at the morning time, daytime and nighttime.

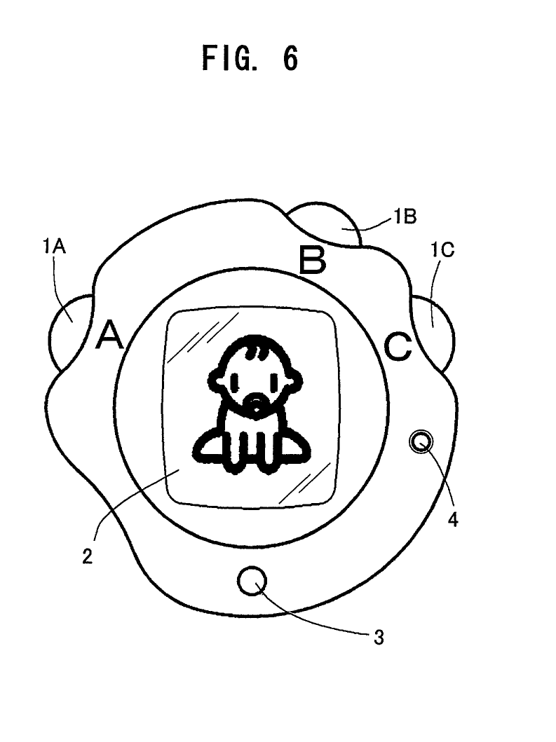

After completion of setting the training start time, the display unit displays a normal screen. In particular, as shown in FIG. 6, the character display unit 2 displays a picture of a baby that is appeared according to the scenario described hereafter (step S6). While displaying this normal screen the basic process including updating the time and detection of walking steps is performed (step S7). Thereafter the decision is made whether the user is going to perform the pelvic floor muscle training or whether the user has depressed any one of the switches in the operation switch section 1 (step S8). If no switch has been depressed the routine returns to the normal display screen in step S6 to continue the basic process.

If either switch has been depressed then the decision is made whether the current time matches to the training start time for the pelvic floor muscle training (step S9). If so, the routine enters the training mode. After completion of the training the routine returns to the normal display screen in step S6 to continue the basic process.

Now the basic process will be described in more detail.

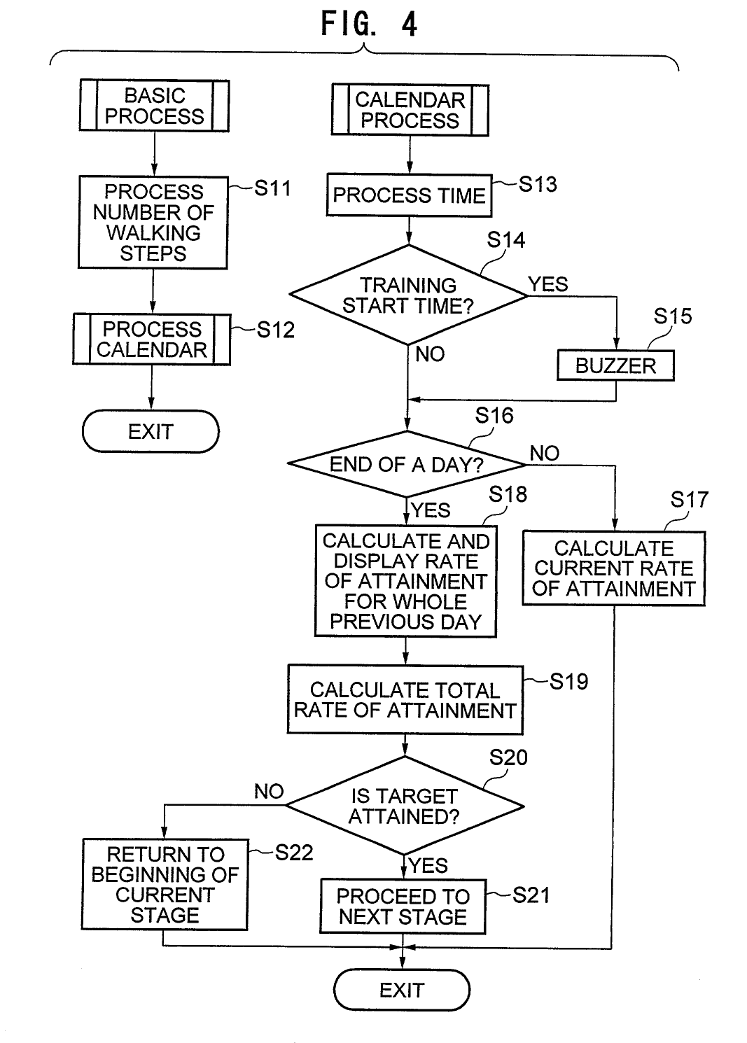

FIG. 4 is a flow chart illustrating the basic process routine. The basic process includes processing of the number of walking steps (step S11) and processing of calendar (step S12). In processing of the number of walking steps the step counter unit 5 produces a signal every time when any vibration due to the walking of the user is detected by a detector (or a walk sensor) therein and sends it to the microcomputer 6 for storage in a memory. The number of steps is counted in the memory of the microcomputer 6 and is displayed on the character display unit 2. The configuration for counting the number of steps is substantially same as that in the common step counter or pedometer, and therefore, no further description will be made here.

Processing of calendar is to measure the current time for the purpose of managing the training start time for the pelvic floor muscle training and the end of a day or a change of a day. A timer in the microcomputer 6 is used for managing the current time (step S13).

After processing of calendar the decision is made whether it is the time to start the pelvic floor muscle training (step S14). If so, the sound section 8 sounds a buzzer to inform the user of this fact (step S15).

Next the decision is made whether the change of a day has occurred (step S16). If not, the current value of the number of walking steps counted is compared with a target value required for getting the predetermined effect for the user. Then the rate of attainment is calculated based on the comparison and is displayed on the character display unit 2 (step S17). If the change of a day has occurred or the day has ended, the rate of attainment for the training and the walking relative to the respective target values is calculated for a whole previous day (step S18).

Now, the calculation of the target value for a day and the corresponding score, and the training method will be described in detail. In the pelvic floor muscle training the different target values are separately set for the fast fiber and slow fiber muscle trainings. In case of the fast fiber muscle training a picture illustrating an action to push the switch is displayed on the character display unit 2 repeatedly for a period of 1 sec. Similarly the LED in the timing indicator unit 3 flashes at the rate of 1 sec.

Then the user depresses the switch 1A in synchronism with the flashing of the LED. At the same time, the user exerts herself to contract the muscles of vagina and anus. That is to say, every time when exercising to contract the muscles, the user depresses the switch 1A and then the device interprets that the user has performed the quick muscle training for pelvic floor muscles (or the user has exerted herself to contract the muscles of vagina and anus) and makes her to perform this exercise for a period of 1 min. Because of 30 times flashing of the LED in the timing indicator unit 3 during the period of 1 min., the device counts the number of depressing of the switch 1A relative to the 30 times flashing of the LED.

In case of the slow fiber muscle training the picture illustrating an action to push the switch is displayed on the character display unit 2 for a period of 10 sec. Similarly the LED in the timing indicator unit 3 flashes at the rate of 10 sec. Then the user depresses the switch 1A for a period of 10 sec., in synchronism with the flashing of the LED. And at the same time, the user continues to contract the muscles of vagina and anus for that time period. Based upon the fact that the switch 1A is kept depressed for that time period the device interprets that the user has performed the slow muscle training for pelvic floor muscles. After performing this exercise for a period of 10 sec., the user takes a rest for a period of 10 sec., and then repeats the exercise in the same manner. The user repeats such 10 sec-exercise three times and the device measures how long the switch 1A has been depressed within the total time period of 1 min.

The target values for the user are set at 80% of theoretical values for the quick and slow muscle trainings, and if the target value is attained, the story proceeds according to the predetermined scenario. In particular, unless the device counts at least 80% of 30 times or 24 times for the quick muscle training, and the device measures at least the time period of 80% of 30 sec or 24 sec for the slow muscle training, it is not determined that the pelvic floor muscle training has correctly been performed. Therefore, the picture of the baby displayed on the character display unit 2 remains unchanged. The actual values at each of three training processes at morning time, daytime and nighttime are stored. For a walking exercise, the target value for the number of steps a day is set at 10,000. Unless the user attains such target value the picture displayed on the character display unit 2 according to the scenario remains unchanged.

As described above, the device according to the present invention is configured in such manner that the target values for the pelvic floor muscle training and the walking are imposed to the user and if no such target values are attained the picture displayed on the character display unit 2 according to the scenario remains unchanged. Now, the scenario unit and the controller for changing the picture displayed on the character display unit 2 in response to the attainment of the target values will be described in more detail. In this embodiment the scenario unit and the controller are implemented by a software program installed in the memory of the microcomputer 6. For example, the scenario unit can change the picture displayed on the character display unit 2 according to the predetermined scenario in response to the degree of attainment for the target values. Such scenario unit is formed by application of those used in various types of game machines and is configured to produce several pictures according to the scenario having a plurality of stages. In this preferred embodiment of the present invention the pictures illustrating the grown up of a person, for example, character pictures of a baby, a child, a school child, a junior high school student, a high school student, a university student, an adult, etc., are selectively displayed. The controller determines which of the character pictures is to be displayed on the character display unit 2 according to the transition of the stages of the scenario given by the scenario unit, in response to the degree of attainment for the target value of the training. In this way a total score for a day is calculated based on the results of the training at the morning time, daytime and nighttime, and the number of steps for the day. The total score is used to select any one of the character pictures to be displayed on the character display unit 2, in order to change the degree of grown up of the character, which prompts the user to perform the training.

In addition the device of the present invention checks the total rate of attainment for every week, and if the target value for a week is attained, the story proceeds to the next stage of the scenario.

Accordingly the total rate of attainment from the start of the current stage is calculated (step S19). Then the decision is made whether the target value for that stage is attained (step S20). If so, the routine proceeds to the next stage (step S21). Otherwise the routine returns to the start of the current stage and performs it once again (step S22).

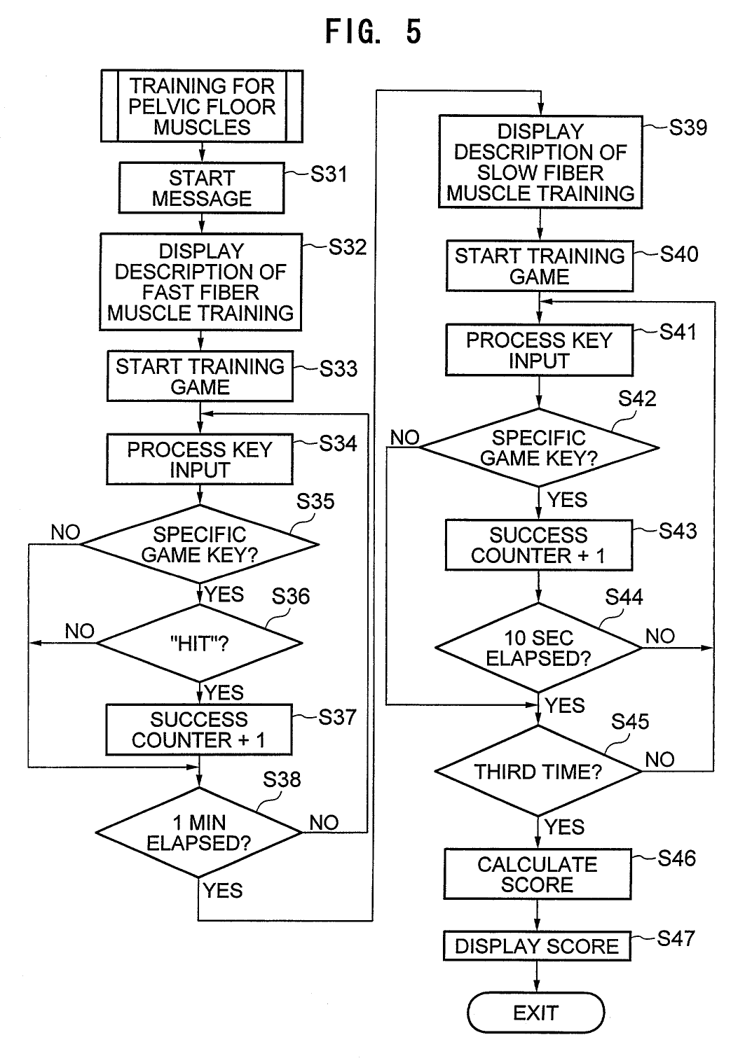

FIG. 5 is a flow chart illustrating a pelvic floor muscle training routine according to the present invention. When entering the pelvic floor muscle training mode a message indicating the start of the exercise is displayed on the character display unit 2 (step S31), and a description for the fast fiber muscle training is initially displayed on the character display unit 2 (step S32). Then, after a count down display, the pelvic floor muscle training is started (step S33). At the same time, key input becomes possible with the switch 1A (step S34). As described before, a display that prompts to depress the switch appears on the screen and the LED of the timing indicator unit 3 flashes at the rate of 1 sec. Then the user depresses the switch 1A in synchronism with the flashing of the LED. The flashing of the LED at the rate of 1 sec is independently produced by the microcomputer 6, and therefore, it is not shown in the flow chart. Concurrently with the flashing of the LED the user exerts herself to contract the muscles of vagina and anus. Thereafter, the device makes decision whether the switch 1A is depressed (step S35). Then the device makes decision whether the switch input is matched to the flashing of the LED of the timing indicator unit 3, and if so, the device determines that the training is correctly performed (“hit”) (step S36). If the device determines “hit” the microcomputer 6 increments a fast fiber training success counter included therein by one (step S37). Next the decision is made whether the time period of 1 min has been elapsed from the start of the training (step S38). If not, the routine is repeated until the time period of 1 min has been elapsed. In such way the user repeats a cycle of 1 sec-exercise of vagina and anus muscle contraction and 1 sec-rest during the time period of 1 min.

After completion of fast fiber muscle training the slow fiber muscle training is started. A description for the slow fiber muscle training is displayed on the character display unit 2 (step S39). Then, after a count down display, the slow fiber muscle training is started (step S40). At the same time, key input becomes possible with the switch 1A (step S41). Then a display that prompts to depress the switch 1A appears on the screen of the timing indicator unit 2 and the LED of the timing indicator unit 3 flashes at the rate of 10 sec. Then the user keeps depressed the switch 1A in synchronism with the flashing of the LED for a period of 10 sec. Concurrently the user continues to contract the muscles of vagina and anus. Thereafter, the device makes decision whether the switch 1A is kept depressed in synchronism with the flashing of the LED (step S42). If so, the device increments a slow training success counter by one (step S43). Next the decision is made whether the time period of 10 sec has been elapsed (step S44). Accordingly if the switch 1A is correctly kept depressed the slow training success counter is incremented by a value corresponding to the time (in sec) during which the switch is kept depressed. After the time period of 10 sec the user relaxes the muscle for a subsequent time period of 10 sec. The user repeats this cycle of the slow fiber muscle training three times (step S45).

After completion of both fast fiber and slow fiber muscle trainings the degree of correctness of the pelvic floor muscle trainings is determined based upon the counted values and the corresponding score is calculated (step S46). The score calculated is displayed on the character display unit 2 to make the user understood as to whether the training has correctly been performed (step S47). The score is used as a criterion for judging when the current rate of attainment is calculated in step S17 of the basic routine.

There has been described one embodiment of the present invention in which proceeding of the story according to the scenario is changed depending upon the effort paid to the pelvic floor muscle training and the number of walking steps. The present invention is, however, not limited to such embodiment, but various modifications and other embodiments may be possible within the scope of the present invention. For example, proceeding of the story may be changed only depending on the effort paid to the pelvic floor muscle training, or depending on other data for judging such as consumed calorie or burned fat amount, as derived from the number of steps counted and the personal data including height, body weight, sex, age, step width, etc.

In the embodiment as described above the pelvic floor muscle training is performed three times a day, i.e., at morning time, daytime and nighttime. And the pelvic floor muscle training includes muscle training in which a cycle of 1 sec-contraction and 1 sec-relaxation of vagina and anus muscles is repeated for a period of 1 min; and slow fiber muscle training in which a cycle of 10 sec-contraction and 10 sec-relaxation of vagina and anus muscles is repeated for a period of 1 min. The present invention is, however, not limited to such numerical values, but the time period and the number of times for the training may be altered.

In addition setting of the target value imposed to the user for a day may be changed depending on the personal data of the user. For example, the target of the number of walking steps for the user having heavier body weight may be set at higher value, while that for the user of higher age may be set at lower value in view of the bodily power.

In the embodiment as described above, the timing indication for the pelvic floor muscle training is formed by the visible indication such as the flashing of the LED. However, the present invention is not limited to such visible timing indication, but other indication may be used. For example, an audible indication such as a sound produced by a buzzer may be used. Alternatively a vibration mechanism may be provided in the device for producing an indication by the vibration of the device itself. Therefore the sound indication may be produced or the vibration may be given for the training indication during the contraction of vagina and anus muscles.

Furthermore, the portable type device for supporting the training for prevention against incontinence of urine, as described above, uses the story of growing up of a character or a baby. The present invention is, however, not limited to such story, but any other suitable story according to the scenario may be used if it provides some game like function or other interested function that prompts the user to continue the training.

It is apparent from the foregoing that the device of the present invention greatly supports the user to perform the training for prevention against incontinence of urine according to the most effective schedule and the method provided by the device.

It is well known that corpulent persons are likely to be suffered from the incontinence of urine. By incorporating the step counter or pedometer function into the device for supporting the training for prevention against incontinence of urine, the user is prompted to perform both the training and the walking, which effectively provides the remedy for, and the prevention against, incontinence of urine.

Furthermore, by providing the device with some game like function for pleasuring the user, any repugnance and dislike to the training becomes relieved, and it becomes possible to make it a practice to perform the training. Thus the remedy for, and the prevention against, incontinence of urine can effectively be achieved even with pleasure.

Finally, by setting the exercise start time and sounding the buzzer at that start time, there becomes no possibility that the user forgets to perform the training, rather the user can continue the training.

What is claimed is:

1. A device for supporting a training for prevention against incontinence of urine, comprising:
an input unit;
an indicator unit;
a decision unit; and
a display unit, whereby
said input unit enters the fact that a user is performing the training for prevention against incontinence of urine;
said indicator unit produces a timing indication for the training for prevention against incontinence of urine;
said decision unit determines that the training for prevention against incontinence of urine is correctly performed on the basis of the input signal sent from the input unit; and
said display unit performs displaying according to the result of decision made by the decision unit.

2. A device for supporting a training for prevention against incontinence of urine, comprising:
an input unit;
an indicator unit;
a step counter unit;
a decision unit; and
a display unit, whereby
said input unit enters the fact that a user is performing the training for prevention against incontinence of urine;
said indicator unit produces a timing indication for the training for prevention against incontinence of urine;
said step counter unit counts the number of steps based on a walking exercise of the user;
said decision unit determines that the training for prevention against incontinence of urine is correctly performed on the basis of the input signal sent from the input means; and
said display unit performs displaying according to the result of decision made by the decision unit and the number of steps counted by the step counter unit.

3. A device for supporting a training for prevention against incontinence of urine, incorporating a step counting function, comprising:
an input unit;
an indicator unit;
a step counter unit;
a decision unit;
a timer unit;
a training effort determination unit;
a display unit;
a scenario unit; and
a controller unit, whereby
said input unit enters the fact that a user is performing the training for prevention against incontinence of urine;
said indicator unit produces a timing indication for the training for prevention against incontinence of urine;
said step counter unit counts the number of steps based on a walking exercise of the user;
said decision unit determines that the training for prevention against incontinence of urine is correctly performed on the basis of the input signal sent from the input means;
said timer unit controls the time;
said training effort determination unit determines a degree of the training effort on the basis of the result of decision made by the decision unit and/or the number of steps counted by the step counter unit within the predetermined time period controlled by the timer unit;
said display unit displays the degree of the training effort determined by the training effort determination unit;
said scenario unit changes the display of the degree of the training effort according to the predetermined scenario including a plurality of stages; and
said controller unit controls the transition of the stages of said predetermined scenario by the scenario unit, based on the degree of the training effort determined by the training effort determination unit.

4. A device for supporting a training for prevention against incontinence of urine according to any one of claims 1 to 3 in which said training for prevention against incontinence of urine is a pelvic floor muscle training including fast fiber muscle and slow fiber muscle trainings.

5. A device for supporting a training for prevention against incontinence of urine according to claim 4 in which said indicator unit produces the different timing indications for the fast fiber muscle and slow fiber muscle trainings.

6. A device for supporting a training for prevention against incontinence of urine according to claim 5 in which the timing indication for the fast fiber muscle training is such that relatively short exercise interval and rest interval are repeated with the same time period, and the timing indication for the slow fiber muscle training is such that relatively long exercise interval and rest interval are repeated alternately.

7. A device for supporting a training for prevention against incontinence of urine according to claim 6 in which said relatively short exercise interval and rest interval for the fast fiber muscle training are repeated with the same time period of around 1 sec, and said relatively long exercise interval and rest interval for the slow fiber muscle training are repeated alternately with the time period of around 10 sec.

8. A device for supporting a training for prevention against incontinence of urine according to claim 3 in which it further comprises:
an exercise start time setting unit; and
an announcement unit, whereby
said exercise start time setting unit enters an exercise start time at which the user starts the training for prevention against incontinence of urine; and
said announcement unit announces when the timer unit indicates the exercise start time.

9. A device for supporting a training for prevention against incontinence of urine according to any one of claims 1 to 3 in which the timing indication for the training produced by said indicator unit is a visible indication.
